(19) United States
(12) Patent Application Publication
(10) Pub. No.: US 2021/0116022 A1
(43) Pub. Date: Apr. 22, 2021

(54) CONTROL DEVICE FOR VEHICULAR TRANSMISSION

(71) Applicant: TOYOTA JIDOSHA KABUSHIKI KAISHA, Toyota-shi (JP)

(72) Inventors: Atsushi AYABE, Toyota-shi (JP); Kunio HATTORI, Nagoya-shi (JP); Jun AMANO, Toyota-shi (JP); Asami FUJITA, Toyota-shi (JP)

(73) Assignee: TOYOTA JIDOSHA KABUSHIKI KAISHA, Toyota-shi (JP)

(21) Appl. No.: 16/939,666

(22) Filed: Jul. 27, 2020

(30) Foreign Application Priority Data
Oct. 18, 2019 (JP) 2019-191416

(51) Int. Cl. F16H 61/70; F16H 37/02

(52) U.S. Cl. CPC F16H 61/702; F16H 59/48; F16H 37/022

(57) ABSTRACT

When a rotation speed difference between rotary members of a mode switching clutch is equal to or less than a predetermined value during travel in a belt travel mode, there is a likelihood that the mode switching clutch would be secured to a lock mode in which power operating in two directions is transmitted. At this time, since switching to a gear travel mode is prohibited, it is possible to curb occurrence of a shock when power is simultaneously transmitted via a first power transmission path and a second power transmission path in a transition period of switching to the gear travel mode.

### INCORPORATION BY REFERENCE

The disclosure of Japanese Patent Application No. 2019-191416 filed on Oct. 18, 2019 including the specification, drawings and abstract is incorporated herein by reference in its entirety.

### BACKGROUND

### 1. Technical Field

The present disclosure relates to a control device for a vehicular transmission that includes a first power transmission path and a second power transmission path in parallel.

### 2. Description of Related Art

A vehicular transmission that is provided between a drive source and driving wheels and includes a first power transmission path and a second power transmission path in parallel is known. An example of such a vehicular transmission is described in Japanese Patent No. 5765485 (a power transmission device for a vehicle in Japanese Patent No. 5765485). In the vehicular transmission described in Japanese Patent No. 5765485, a first clutch and a third clutch including a dog clutch are provided in the first power transmission path, and a second clutch is provided in the second power transmission path. Power of a drive source is transmitted to the driving wheels via the first power transmission path or the second power transmission path by switching between engagement states of the first to third clutches.

### SUMMARY

In Japanese Patent No. 5765485, it is conceivable that a one-way clutch that transmits power operating in one direction and cuts off power operating in the opposite direction or a mode switching clutch that is able to switch to at least a one-way mode in which it serves as a one-way clutch be employed instead of the third clutch which is provided in the first power transmission path. In the vehicular transmission having the above configuration, when the one-way clutch or the mode switching clutch is out of order and is secured to a state in which power operating in two directions is transmitted during travel in a state in which power of the drive source is transmitted via the second power transmission path, there is concern about occurrence of a shock due to simultaneous transmission of power through the first power transmission path and the second power transmission path when the first clutch is engaged to switch the power transmission path to the first power transmission path.

The present disclosure provides a control device that curbs a shock which is generated when a one-way clutch or a mode switching clutch which is provided in a first power transmission path is secured to a state in which power operating in two directions is transmitted in a vehicular transmission that is provided between a drive source and driving wheels and includes the first power transmission path and a second power transmission path which are provided in parallel.

According to a first aspect of the present disclosure, there is provided (a) a control device for a vehicular transmission that is provided between an input shaft which is connected to a drive source in a power-transmittable manner and an output shaft which is connected to driving wheels in a power-transmittable manner and includes at least a first power transmission path and a second power transmission path which are provided in parallel, in which a first clutch and a power transmission mechanism are provided in the first power transmission path, a stepless gear shifting mechanism and a second clutch are provided in the second power transmission path, and the first clutch is disposed closer to the drive source than the power transmission mechanism, (b) wherein the power transmission mechanism includes a mode switching clutch or a one-way clutch that is able to switch to at least a one-way mode in which power operating in one direction is transmitted and power operating in the opposite direction is cut off, and (c) wherein switching to a travel mode in which power of the drive source is transmitted to the driving wheels via the first power transmission path is prohibited when a rotation speed difference between rotary members of the power transmission mechanism is equal to or less than a predetermined value during travel in a travel mode in which the power of the drive source is transmitted to the driving wheels via the second power transmission path.

A second aspect of the present disclosure provides the control device for a vehicular transmission according to the first aspect, wherein the first clutch is disengaged when an amount of change of a rotation speed of the input shaft with the progress of switching is equal to or less than a predetermined value in a transition period of switching from the travel mode in which the power of the drive source is transmitted to the driving wheels via the first power transmission path to the travel mode in which the power of the drive source is transmitted to the driving wheels via the second power transmission path.

A third aspect of the present disclosure provides the control device for a vehicular transmission according to the first aspect, wherein the first clutch is disengaged when deceleration of a vehicle in a transition period of switching from the travel mode in which the power of the drive source is transmitted to the driving wheels via the first power transmission path to the travel mode in which the power of the drive source is transmitted to the driving wheels via the second power transmission path is equal to or greater than a predetermined value.

In the control device for a vehicular transmission according to the first aspect, when a rotation speed difference between rotary members of the power transmission mechanism is equal to or less than a predetermined value during travel in the travel mode in which the power of the drive source is transmitted to the driving wheels via the second power transmission path, there is a likelihood that the power transmission mechanism will be secured to a state in which power operating in two directions is transmitted. At this time, since switching to the travel mode in which the power of the drive source is transmitted to the driving wheels via the first power transmission path is prohibited, it is possible to curb occurrence of a shock when the power is simultaneously transmitted via the first power transmission path and the second power transmission path in the transition period of switching to the travel mode in which the power of the drive source is transmitted to the driving wheels via the first power transmission path.

In the control device for a vehicular transmission according to the second aspect, when a change in rotation with the progress of switching does not occur in the transition period of switching from the travel mode in which the power of the drive source is transmitted to the driving wheels via the first power transmission path to the travel mode in which the power of the drive source is transmitted to the driving wheels via the second power transmission path, there is a likelihood that the power transmission mechanism will be secured to the state in which power operating in two directions is transmitted. On the other hand, since the first clutch is disengaged when the amount of change of the rotation speed of the input shaft with the progress of switching in the transition period of switching is equal to or less than the predetermined value, it is possible to curb occurrence of a shock when the power is simultaneously transmitted via the first power transmission path and the second power transmission path.

In the control device for a vehicular transmission according to the third aspect, when the deceleration of the vehicle increases in the transition period of switching from the travel mode in which the power of the drive source is transmitted to the driving wheels via the first power transmission path to the travel mode in which the power of the drive source is transmitted to the driving wheels via the second power transmission path, there is a likelihood that the power transmission mechanism will be secured to the state in which power operating in two directions is transmitted. On the other hand, since the first clutch is disengaged when the deceleration of the vehicle is equal to or greater than the predetermined value in the transition period of switching, it is possible to curb occurrence of a shock when the power is simultaneously transmitted via the first power transmission path and the second power transmission path.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram schematically illustrating a configuration of a vehicle to which the present disclosure is applied and a control system of an electronic control unit that controls the vehicle;

FIG. 2 is a sectional view schematically illustrating a structure of a mode switching clutch illustrated in FIG. 1, where a part in a circumferential direction of the mode switching clutch is cut away and extended, and particularly illustrating a state in which the mode switching clutch is switched to a one-way mode;

FIG. 3 is a sectional view schematically illustrating a structure of the mode switching clutch illustrated in FIG. 1, where a part in a circumferential direction of the mode switching clutch is cut away and extended, and particularly illustrating a state in which the mode switching clutch is switched to a lock mode;

FIG. 4 is an engagement operation table illustrating engagement states of engagement devices for each operation position which is selected by a shift lever which is provided in the vehicle and which is not illustrated;

FIG. 5 is a diagram schematically illustrating a hydraulic pressure control circuit that controls an operating state of a transmission illustrated in FIG. 1;

FIG. 6 is a flowchart illustrating a principal part of a control operation which is performed by the electronic control unit illustrated in FIG. 1 and which is used to curb occurrence of a shock when power is simultaneously transmitted via a first power transmission path and a second power transmission path;

FIG. 7 is a functional block diagram illustrating a control function of an electronic control unit according to another embodiment of the present disclosure; and

FIG. 8 is a flowchart illustrating a principal part of a control operation which is performed by the electronic control unit illustrated in FIG. 7 and which is used to curb occurrence of a shock when power is simultaneously transmitted via a first power transmission path and a second power transmission path.

### DETAILED DESCRIPTION OF EMBODIMENTS

Hereinafter, embodiments of the present disclosure will be described in detail with reference to the accompanying drawings. In the following embodiments, the drawings are appropriately simplified or modified, and dimensional ratios, shapes, and the like of constituent elements are not necessarily illustrated accurately.

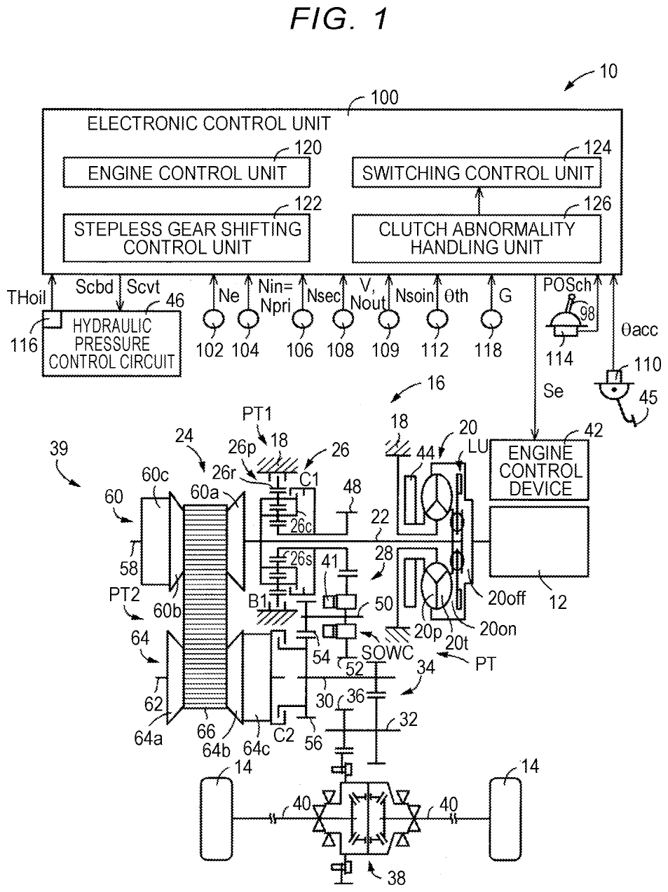

FIG. 1 is a diagram schematically illustrating a configuration of a vehicle 10 to which the present disclosure is applied and a control system of an electronic control unit 100 that controls the vehicle 10. In FIG. 1, the vehicle 10 includes a vehicular power transmission device 16 (hereinafter referred to as a power transmission device 16) that transmits power of an engine 12 to driving wheels 14.

The power transmission device 16 is provided between the engine 12 and the driving wheels 14. In a case 18 as a non-rotational member, the power transmission device 16 includes a known torque converter 20 which is a hydraulic transmission device connected to the engine 12, an input shaft 22 that is connected to the torque converter 20, a belt type stepless gear shifting mechanism 24 that is connected to the input shaft 22, a forward/reverse travel switching device 26 that is connected to the input shaft 22 in the same way, a gear mechanism 28 that is connected to the input shaft 22 via the forward/reverse travel switching device 26 and is provided in parallel with the stepless gear shifting mechanism 24, an output shaft 30 which is an output rotary member which is shared with the stepless gear shifting mechanism 24 and the gear mechanism 28, a counter shaft 32, a reduction gear device 34 that is provided to be relatively non-rotatable with respect to the output shaft 30 and the counter shaft 32 and includes a pair of gears engaging with each other, a gear 36 that is provided to be relatively non-rotatable with respect to the counter shaft 32, a differential device 38 that is connected to the gear 36 in a power-transmittable manner, and right and left axles 40 that are connected to the differential device 38.

In the power transmission device 16 having the above configuration, power which is output from the engine 12 is transmitted to the right and left driving wheels 14 sequentially via the torque converter 20, the forward/reverse travel switching device 26, the gear mechanism 28, the reduction gear device 34, the differential device 38, the axles 40, and the like. Alternatively, in the power transmission device 16, power which is output from the engine 12 is transmitted to the right and left driving wheels 14 sequentially via the torque converter 20, the stepless gear shifting mechanism 24, the reduction gear device 34, the differential device 38, the axles 40, and the like. The power is synonymous with a torque or a force when they are not particularly distinguished from each other.

The power transmission device 16 includes a first power transmission path PT1 and a second power transmission path PT2 which are provided in parallel between the input shaft 22 and the output shaft 30. The first power transmission path PT1 includes the gear mechanism 28, and the second power transmission path PT2 includes the stepless gear shifting mechanism 24. A vehicular transmission 39 (hereinafter referred to as a transmission 39) is constituted by the first power transmission path PT1 and the second power transmission path PT2 which are provided in parallel. That is, the transmission 39 includes the first power transmission path PT1 and the second power transmission path PT2 which are provided in parallel between the input shaft 22 that is connected to the engine 12 in a power-transmittable manner and the output shaft 30 that is connected to the driving wheels 14 in a power-transmittable manner.

The first power transmission path PT1 is a power transmission path that includes a forward/reverse travel switching device 26 including a first clutch C1 and a first brake B1, a gear mechanism 28, and a mode switching clutch SOWC and transmits power of the engine 12 from the input shaft 22 to the driving wheels 14 via the gear mechanism 28. In the first power transmission path PT1, the forward/reverse travel switching device 26, the gear mechanism 28, and the mode switching clutch SOWC are sequentially arranged from the engine 12 toward the driving wheels 14. That is, the first clutch C1 is disposed to be closer to the engine 12 (upstream) than the mode switching clutch SOWC. The second power transmission path PT2 is a power transmission path that includes a stepless gear shifting mechanism 24 and a second clutch C2 and transmits power of the engine 12 from the input shaft 22 to the driving wheels 14 via the stepless gear shifting mechanism 24. In the second power transmission path PT2, the stepless gear shifting mechanism 24 and the second clutch C2 are sequentially arranged from the engine 12 to the driving wheels 14. The mode switching clutch SOWC corresponds to a power transmission mechanism in the claims.

The forward/reverse travel switching device 26 includes a double pinion type planetary gear device 26p, the first clutch C1, and the first brake B1. The planetary gear device 26p is a differential mechanism including three rotary members of a carrier 26c which is an input element, a sun gear 26s which is an output element, and a ring gear 26r which is a reaction element. The carrier 26c is connected to the input shaft 22. The ring gear 26r is selectively connected to a case 18 via the first brake B1. The sun gear 26s is disposed on an outer circumference side of the input shaft 22 and is connected to a small-diameter gear 48 which is provided to be rotatable relative to the input shaft 22. The carrier 26c and the sun gear 26s are selectively connected to each other via the first clutch C1.

The gear mechanism 28 includes the small-diameter gear 48, a counter shaft 50, and a large-diameter gear 52 that is provided to be rotatable relative to the counter shaft 50 and engages with the small-diameter gear 48. A counter gear 54 that engages with an output gear 56 which is provided in the output shaft 30 is provided in the counter shaft 50 to be non-rotatable relative to the counter shaft 50.

The stepless gear shifting mechanism 24 includes a primary shaft 58 that is provided coaxially with the input shaft 22 and integrally connected to the input shaft 22, a primary pulley 60 that is connected to the primary shaft 58 and has a variable effective diameter, a secondary shaft 62 that is provided coaxially with the output shaft 30, a second pulley 64 that is connected to the secondary shaft 62 and has a variable effective diameter, and a transmission belt 66 which is a transmission element that is suspended between the pulleys 60 and 64. The stepless gear shifting mechanism 24 is a known belt type stepless gear shifting mechanism in which transmission of power is performed by a frictional force between the pulleys 60 and 64 and the transmission belt 66, and transmits power of the engine 12 to the driving wheels 14. The effective diameter of the primary pulley 60 is changed by a hydraulic actuator 60c which will be described later, and the effective diameter of the second pulley 64 is changed by a hydraulic actuator 64c which will be described later.

A gear ratio EL (=input-shaft rotation speed Nin/output-shaft rotation speed Nout) in the first power transmission path PT1 which is constituted by the gear mechanism 28 is set to a value greater than a lowest gear ratio γmax of the stepless gear shifting mechanism 24 which is the maximum gear ratio in the second power transmission path PT2. That is, the gear ratio EL is set to a gear ratio which is lower than the lowest gear ratio γmax. Accordingly, a gear ratio which is higher than that in the first power transmission path PT1 is formed in the second power transmission path PT2. The input-shaft rotation speed Nin is a rotation speed of the input shaft 22 and the output-shaft rotation speed Nout is a rotation speed of the output shaft 30.

In the transmission 39, a power transmission path PT that transmits the power of the engine 12 to the driving wheels 14 is switched between the first power transmission path PT1 and the second power transmission path PT2 depending on the travel state of the vehicle 10. Accordingly, the transmission 39 includes a plurality of engagement devices that selectively forms the first power transmission path PT1 and the second power transmission path PT2. The plurality of engagement devices includes the first clutch C1, the first brake B1, the second clutch C2, and the mode switching clutch SOWC.

The first clutch C1 is an engagement device that is provided in the first power transmission path PT1 and selectively sets up or intercepts the first power transmission path PT1, and is an engagement device that is engaged such that the first power transmission path PT1 can transmit power at the time of forward travel of the vehicle. The first brake B1 is an engagement device that is provided in the first power transmission path PT1 and selectively sets up or intercepts the first power transmission path PT1, and is an engagement device that is engaged such that the first power transmission path PT1 can transmit power at the time of reverse travel of the vehicle. The first power transmission path PT1 is set up by engagement of the first clutch C1 or the first brake B1.

The mode switching clutch SOWC is provided in the first power transmission path PT1 and is configured to switch between a one-way mode in which power operating in a driving direction of the vehicle 10 (power operating in one direction) at the time of forward travel is transmitted and power operating in a driven direction of the vehicle 10 (power operating in the opposite direction) at the time of forward travel is intercepted and a lock mode in which power is transmitted in the driving direction and the driven direction of the vehicle 10.

For example, in a state in which the first clutch C1 is engaged and the mode switching clutch SOWC is switched to the one-way mode, the mode switching clutch SOWC can transmit power in a driving state of the vehicle 10 which is traveling forward with the power of the engine 12. That is, the power of the engine 12 is transmitted to the driving wheels 14 via the mode switching clutch SOWC at the time of forward travel. On the other hand, even in the state in which the first clutch C1 is engaged and the mode switching clutch SOWC is switched to the one-way mode, the mode switching clutch SOWC intercepts transmission of power in a driven state of the vehicle 10 which is coasting or the like. The driving state of the vehicle 10 corresponds to a state in which the torque of the input shaft 22 has a positive value with respect to the travel direction, substantially, in a state in which the vehicle 10 is driven with the power of the engine 12. The driven state of the vehicle corresponds to a state in which the torque of the input shaft 22 has a negative value with respect to the travel direction, substantially, a state in which the vehicle 10 is coasting and a rotary member which is mechanically connected to the driving wheels 14 corotates with rotation transmitted from the driving wheels 14.

In a state in which the first clutch C1 is engaged and the mode switching clutch SOWC is switched to the lock mode, the mode switching clutch SOWC can transmit power in the driving state and the driven state of the vehicle 10, that is, transmit power operating in two directions (the forward direction and the reverse direction), and can generate engine brake by transmitting the power of the engine 12 to the driving wheels 14 via the first power transmission path PT1 and transmitting rotation transmitted from the driving wheels 14 to the engine 12 via the first power transmission path PT1 at the time of coasting (in the driven state of the vehicle 10). In the state in which the first brake B1 is engaged and the mode switching clutch SOWC is switched to the lock mode, power operating in the reverse direction and transmitted from the engine 12 is transmitted to the driving wheels 14 via the mode switching clutch SOWC, and reverse travel via the first power transmission path PT1 is possible. The structure of the mode switching clutch SOWC will be described later.

The second clutch C2 is an engagement device that is provided in the second power transmission path PT2 and sets up or intercepts the second power transmission path PT2 and is an engagement device that is engaged such that the second power transmission path PT2 can transmit power at the time of forward travel. The second clutch C2 is a known hydraulic wet frictional engagement device that is frictionally engaged by a hydraulic actuator.

The power transmission device 16 includes a mechanical oil pump 44 that is connected to a pump impeller 20p. The oil pump 44 is rotationally driven by the engine 12 to generate a source pressure for a hydraulic oil pressure for controlling gear shifting of the stepless gear shifting mechanism 24, generating a belt clamping pressure in the stepless gear shifting mechanism 24, switching an operating state such as engagement or disengagement of each of the plurality of engagement devices, and switching an operating state of a lock-up clutch LU and to supply the hydraulic oil pressure to a hydraulic pressure control circuit 46 (see FIG. 5) which is provided in the vehicle 10.

The structure of the mode switching clutch SOWC will be described below. The mode switching clutch SOWC is provided centered on the counter shaft 50. The mode switching clutch SOWC is provided closer to the driving wheels 14 than the first clutch C1 and the gear mechanism 28 in the first power transmission path PT1. The mode switching clutch SOWC is configured to be switched to one of the one-way mode and the lock mode by controlling a hydraulic actuator 41.

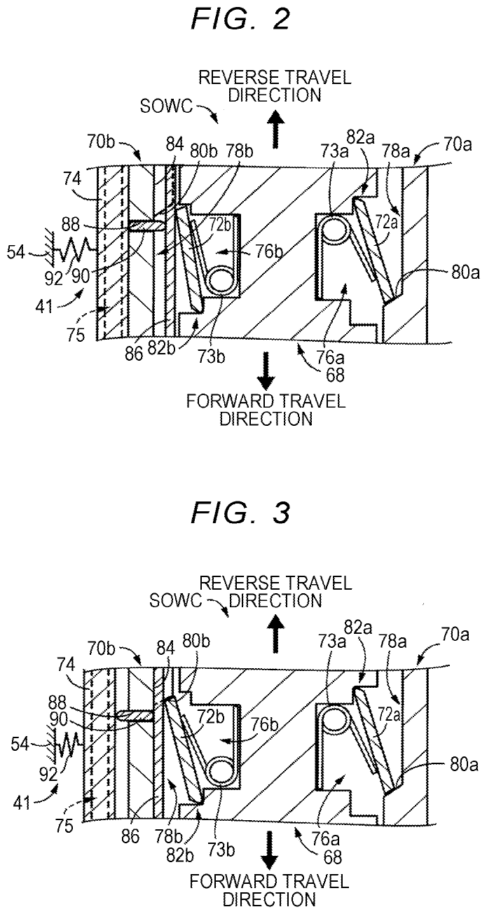

FIGS. 2 and 3 are sectional views schematically illustrating the structure of the mode switching clutch SOWC that enables switching an operating mode between a one-way mode and a lock mode, where a part in a circumferential direction of the mode switching clutch SOWC is cut away and extended. FIG. 2 illustrates a state in which the mode switching clutch SOWC is switched to the one-way mode, and FIG. 3 illustrates a state in which the mode switching clutch SOWC is switched to the lock mode. The up-down direction in FIGS. 2 and 3 corresponds to the rotation direction, the upward direction corresponds to the reverse travel direction of the vehicle (the reverse rotation direction), and the downward direction corresponds to the forward travel direction of the vehicle (the forward rotation direction). The right-left direction in FIGS. 2 and 3 corresponds to an axial direction of the counter shaft 50 (hereinafter, the axial direction corresponds to the axial direction of the counter shaft 50 unless otherwise mentioned), the right side corresponds to the large-diameter gear 52 side in FIG. 1, and the left side corresponds to the counter gear 54 side in FIG. 1.

The mode switching clutch SOWC is formed in a disk shape and is disposed on the outer circumference side of the counter shaft 50. The mode switching clutch SOWC includes an input-side rotary member 68, a first output-side rotary member 70a and a second output-side rotary member 70b that are disposed at positions adjacent to the input-side rotary member 68 in the axial direction, a plurality of first struts 72a and a plurality of torsion coil springs 73a that are interposed between the input-side rotary member 68 and the first output-side rotary member 70a in the axial direction, and a plurality of second struts 72b and a plurality of torsion coil springs 73b that are interposed between the input-side rotary member 68 and the second output-side rotary member 70b in the axial direction.

The input-side rotary member 68 is formed in a disk shape and is provided to be rotatable around the counter shaft 50 relative to the counter shaft 50. The input-side rotary member 68 is disposed to be interposed between the first output-side rotary member 70a and the second output-side rotary member 70b in the axial direction. Engagement teeth of the large-diameter gear 52 are integrally formed on the outer circumference side of the input-side rotary member 68. That is, the input-side rotary member 68 and the large-diameter gear 52 are integrally formed by molding. The input-side rotary member 68 is configured to transmit power to the engine 12 via the gear mechanism 28, the forward/reverse travel switching device 26, and the like.

On a surface of the input-side rotary member 68 facing the first output-side rotary member 70a in the axial direction, a first accommodation portion 76a in which the first strut 72a and the torsion coil spring 73a are accommodated is formed. A plurality of first accommodation portions 76a is formed at intervals with equal angles therebetween in the circumferential direction. ON a surface of the input-side rotary member 68 facing the second output-side rotary member 70b in the axial direction, a second accommodation portion 76b in which the second strut 72b and the torsion coil spring 73b are accommodated is formed. A plurality of second accommodation portions 76b is formed at intervals with equal angles therebetween in the circumferential direction. The first accommodation portion 76a and the second accommodation portion 76b are formed at the same positions in a radial direction of the input-side rotary member 68.

The first output-side rotary member 70a is formed in a disk shape and is disposed to be rotatable around the counter shaft 50. The first output-side rotary member 70a is fixed to the counter shaft 50 in a relatively non-rotatable manner and thus rotates integrally with the counter shaft 50.

On a surface of the first output-side rotary member 70a facing the input-side rotary member 68 in the axial direction, a first concave portion 78a which is recessed in a direction away from the input-side rotary member 68 is formed. The same number of first concave portions 78a as the number of first accommodation portions 76a are formed and are arranged at intervals with equal angles therebetween in the circumferential direction. The first concave portions 78a are formed at the same positions as the first accommodation portions 76a which are formed in the input-side rotary member 68 in the radial direction of the first output-side rotary member 70a.

Accordingly, when the rotational positions of the first accommodation portions 76a and the first concave portions 78a match each other, the first accommodation portions 76a and the first concave portions 78a are adjacent to each other in the axial direction as illustrated in FIGS. 2 and 3. Each first concave portion 78a is formed in a shape which can accommodate one end of the first strut 72a. A first wall surface 80a that comes into contact with one end of the first strut 72a when the input-side rotary member 68 rotates in the forward travel direction (the forward rotation direction, the downward direction in FIGS. 2 and 3) with the power of the engine 12 is formed at one end of each first concave portion 78a in the circumferential direction.

The second output-side rotary member 70b is formed in a disk shape and is disposed to be rotatable around the counter shaft 50. The second output-side rotary member 70b is fixed to the counter shaft 50 in a relatively non-rotatable manner and thus rotates integrally with the counter shaft 50.

On a surface of the second output-side rotary member 70b facing the input-side rotary member 68 in the axial direction, a second concave portion 78b which is recessed in a direction away from the input-side rotary member 68 is formed. The same number of second concave portions 78b as the number of second accommodation portions 76b are formed and are arranged at intervals with equal angles therebetween in the circumferential direction. The second concave portions 78b are formed at the same positions as the second accommodation portions 76b which are formed in the input-side rotary member 68 in the radial direction of the second output-side rotary member 70b.

Accordingly, when the rotational positions of the second accommodation portions 76b and the second concave portions 78b match each other, the second accommodation portions 76b and the second concave portions 78b are adjacent to each other in the axial direction as illustrated in FIGS. 2 and 3. Each second concave portion 78b is formed in a shape which can accommodate one end of the second strut 72b. A second wall surface 80b that comes into contact with one end of the second strut 72b when the input-side rotary member 68 rotates in the reverse travel direction (the reverse rotation direction, the upward direction in FIGS. 2 and 3) with the power of the engine 12 and when the vehicle 10 coasts in the state in which the mode switching clutch SOWC illustrated in FIG. 3 is switched to the lock mode is formed at one end of each second concave portion 78b in the circumferential direction.

Each first strut 72a is formed of a plate-shaped member with a predetermined thickness which is formed in a rectangular shape and is disposed such that the length direction thereof is parallel to the rotation direction (the up-down direction) as illustrated in the cross-sections in FIGS. 2 and 3. The first strut 72a has a predetermined size in a direction perpendicular to the drawing surface of FIGS. 2 and 3.

One end of the first strut 72a in the length direction is biased to the first output-side rotary member 70a side by the torsion coil spring 73a. The other end of the first strut 72a in the length direction is in contact with a first stepped portion 82a which is formed in the corresponding first accommodation portion 76a. The first strut 72a is rotatable around the other end in contact with the first stepped portion 82a. The torsion coil spring 73a is accommodated in the first accommodation portion 76a and biases one end of the first strut 72a to the first output-side rotary member 70a side.

By employing the above-mentioned configuration, when power operating in the forward travel direction (the forward rotation direction) is transmitted to the first strut 72a from the engine 12 in a state in which the mode switching clutch SOWC is switched to the one-way mode (FIG. 2) and the lock mode (FIG. 3), one end of the first strut 72a comes into contact with the first wall surface 80a of the first output-side rotary member 70a and the other end of the first strut 72a comes into contact with the first stepped portion 82a of the input-side rotary member 68. In this state, the relative rotation between the input-side rotary member 68 and the first output-side rotary member 70a is prohibited and power operating in the forward travel direction is transmitted to the driving wheels 14 via the mode switching clutch SOWC. The one-way clutch that transmits power operating in the forward travel direction (the forward rotation direction) to the driving wheels 14 and intercepts power operating in the reverse travel direction (the reverse rotation direction) is constituted by the first struts 72a, the torsion coil springs 73a, the first accommodation portions 76a, and the first concave portions 78a (the first wall surfaces 80a).

Each second strut 72b is formed of a plate-shaped member with a predetermined thickness which is formed in a rectangular shape and is disposed such that the length direction thereof is parallel to the rotation direction (the up-down direction) as illustrated in the cross-sections in FIGS. 2 and 3. The second strut 72b has a predetermined size in the direction perpendicular to the drawing surface of FIGS. 2 and 3.

One end of the second strut 72b in the length direction is biased to the second output-side rotary member 70b side by the torsion coil spring 73b. The other end of the second strut 72b in the length direction is in contact with a second stepped portion 82b which is formed in the corresponding second accommodation portion 76b. The second strut 72b is rotatable around the other end in contact with the second stepped portion 82b. The torsion coil spring 73b is accommodated in the second accommodation portion 76b and biases one end of the second strut 72b to the second output-side rotary member 70b side.

By employing the above-mentioned configuration, when power operating in the reverse travel direction is transmitted to the second strut 72b from the engine 12 in a state in which the mode switching clutch SOWC is switched to the lock mode (FIG. 3), one end of the second strut 72b comes into contact with the second wall surface 80b of the second output-side rotary member 70b and the other end of the second strut 72b comes into contact with the second stepped portion 82b of the input-side rotary member 68. When the vehicle coasts during forward travel, one end of the second strut 72b comes into contact with the second wall surface 80b of the second output-side rotary member 70b and the other end of the second strut 72b comes into contact with the second stepped portion 82b of the input-side rotary member 68. In this state, the relative rotation between the input-side rotary member 68 and the second output-side rotary member 70b is prohibited and power operating in the reverse travel direction is transmitted to the driving wheels 14 via the mode switching clutch SOWC. Rotation which is transmitted from the driving wheels 14 during coasting is transmitted to the engine 12 via the mode switching clutch SOWC. The one-way clutch that transmits power operating in the reverse travel direction (the reverse rotation direction) to the driving wheels 14 and intercepts power operating in the forward travel direction (the forward rotation direction) is constituted by the second struts 72b, the torsion coil springs 73b, the second accommodation portions 76b, and the second concave portions 78b (the second wall surfaces 80b).

In the second output-side rotary member 70b, a plurality of through-holes 88 that penetrates the second output-side rotary member 70b in the axial direction is formed. One end of each through-hole 88 communicates with the corresponding second concave portion 78b. A pin 90 is inserted into and through each through-hole 88. The pin 90 is formed in a cylindrical shape and is movable in the axial direction in the through-hole 88. One end of the pin 90 is in contact with a pressing plate 74 constituting the hydraulic actuator 41 and the other end of the pin 90 is in contact with an annular ring 86.

The ring 86 is formed in the second output-side rotary member 70b, is fitted into a plurality of arc-shaped grooves 84 that is formed to connect the second concave portions 78b adjacent to each other in the circumferential direction, and is allowed to move relatively to the second output-side rotary member 70b in the axial direction.

The hydraulic actuator 41 is disposed at a position adjacent to the second output-side rotary member 70b in the axial direction of the counter shaft 50 on the counter shaft 50 which is the same as the mode switching clutch SOWC.

The hydraulic actuator 41 includes a pressing plate 74, a hydraulic pressure chamber 75 (indicated by a dotted line) that generates a thrust for moving the pressing plate 74 to the counter gear 54 side in the axial direction, that is, to the side which is separated away from the second output-side rotary member 70b in the axial direction, with supply of a hydraulic oil, and a spring 92 that biases the pressing plate 74 to the second output-side rotary member 70b in the axial direction. The hydraulic pressure chamber 75 is provided inward in the radial direction from the position which is in contact with the pin 90 of the pressing plate 74 and thus indicated by a dotted line in FIGS. 2 and 3.

The pressing plate 74 is formed in a ring shape and is disposed to be movable in the axial direction relative to the counter shaft 50. The pressing plate 74 is biased to the second output-side rotary member 70b side in the axial direction by the spring 92. Accordingly, in a state in which a hydraulic oil is not supplied to the hydraulic pressure chamber 75 of the hydraulic actuator 41, as illustrated in FIG. 2, the pressing plate 74 is moved to the second output-side rotary member 70b side in the axial direction by a biasing force of the spring 92 and the pressing plate 74 comes into contact with the second output-side rotary member 70b. At this time, as illustrated in FIG. 2, the pin 90 is moved to the input-side rotary member 68 side by the pressing plate 74, and the ring 86 is also moved to the input-side rotary member 68 side by the pin 90. At this time, one end of the second strut 72b is moved to the input-side rotary member 68 side by the ring 86 and one end of the second strut 72b does not come into contact with the second wall surface 80b. Accordingly, the second strut 72b does not function as a one-way clutch and the mode switching clutch SOWC falls into the one-way mode.

On the other hand, when a hydraulic oil is supplied to the hydraulic pressure chamber 75 of the hydraulic actuator 41, the pressing plate 74 is moved to the counter gear 54 side in the axial direction against the biasing force of the spring 92, and the pressing plate 74 is separated from the second output-side rotary member 70b. At this time, as illustrated in FIG. 3, one end of the second strut 72b, the ring 86, and the pin 90 are moved to the counter gear 54 side in the axial direction by the biasing force of the torsion coil spring 73b. Accordingly, one end of the second strut 72b can come into contact with the second wall surface 80b of the second output-side rotary member 70b and the mode switching clutch SOWC falls into the lock mode.

In the state in which the mode switching clutch SOWC is in the one-way mode as illustrated in FIG. 2, the pressing plate 74 comes into contact with the second output-side rotary member 70b by the biasing force of the spring 92. At this time, the pin 90 is pressed and moved to the input-side rotary member 68 in the axial direction by the pressing plate 74, and the ring 86 is also pressed and moved to the input-side rotary member 68 side in the axial direction by the pin 90. As a result, one end of the second strut 72b is pressed and moved to the input-side rotary member 68 side by the ring 86, and then contact of one end of the second strut 72b with the second wall surface 80b is prohibited. At this time, relative rotation between the input-side rotary member 68 and the second output-side rotary member 70b is permitted and the second strut 72b does not function as a one-way clutch. On the other hand, since one end of the first strut 72a is biased to the first output-side rotary member 70a side by the torsion coil spring 73a and thus comes into contact with the first wall surface 80a of the first concave portion 78a, the first strut 72a functions as a one-way clutch that transmits drive power operating in the forward travel direction.

In the state in which the mode switching clutch SOWC is in the one-way mode as illustrated in FIG. 2, one end of the first strut 72a can come into contact with the first wall surface 80a of the first output-side rotary member 70a. Accordingly, in the driving state of the vehicle 10 in which power operating in the forward travel direction is transmitted from the engine 12 to the mode switching clutch SOWC, one end of the first strut 72a comes into contact with the first wall surface 80a and the other end of the first strut 72a comes into contact with the first stepped portion 82a as illustrated in FIG. 2, whereby relative rotation between the input-side rotary member 68 and the first output-side rotary member 70a in the forward travel direction is prohibited and the power of the engine 12 is transmitted to the driving wheels 14 via the mode switching clutch SOWC. On the other hand, when the vehicle 10 coasts at the time of forward travel and thus the vehicle 10 falls into the driven state, one end of the first strut 72a does not come into contact with the first wall surface 80a of the first output-side rotary member 70a and relative rotation between the input-side rotary member 68 and the first output-side rotary member 70a is permitted, whereby transmission of power via the mode switching clutch SOWC is intercepted. Accordingly, in the state in which the mode switching clutch SOWC is in the one-way mode, the first strut 72a functions as a one-way clutch, power is transmitted in the driving state of the vehicle 10 in which power operating in the forward travel direction is transmitted from the engine 12, and power is intercepted in the driven state of the vehicle 10 in which the vehicle coasts at the time of forward travel.

In the state in which the mode switching clutch SOWC is in the lock mode as illustrated in FIG. 3, a hydraulic oil is supplied to the hydraulic pressure chamber 75 of the hydraulic actuator 41 and thus the pressing plate 74 is moved in the direction in which it is separated away from the second output-side rotary member 70b against the biasing force of the spring 92. At this time, one end of the second strut 72b is moved to the second concave portion 78b of the second output-side rotary member 70b by the biasing force of the torsion coil spring 73b and can come into contact with the second wall surface 80b. Similarly to the one-way mode in FIG. 2, one end of the first strut 72a can come into contact with the first wall surface 80a of the first output-side rotary member 70a.

In the state in which the mode switching clutch SOWC is in the lock mode as illustrated in FIG. 3, when power operating in the forward travel direction is transmitted, one end of the first strut 72a comes into contact with the first wall surface 80a of the first output-side rotary member 70a and the other end of the first strut 72a comes into contact with the first stepped portion 82a, whereby relative rotation between the input-side rotary member 68 and the first output-side rotary member 70a in the forward travel direction is prohibited. When power operating in the reverse travel direction is transmitted in the state in which the mode switching clutch SOWC is in the lock mode, one end of the second strut 72b comes into contact with the second wall surface 80b of the second output-side rotary member 70b and the other end of the second strut 72b comes into contact with the second stepped portion 82b as illustrated in FIG. 3, whereby relative rotation between the input-side rotary member 68 and the second output-side rotary member 70b in the reverse travel direction is prohibited.

In this way, in the state in which the mode switching clutch SOWC is in the lock mode, the first strut 72a and the second strut 72b function as one-way clutches and the mode switching clutch SOWC can transmit power operating in the forward travel direction and the reverse travel direction. Accordingly, at the time of reverse travel, the mode switching clutch SOWC is switched to the lock mode and thus reverse travel is possible. In the driven state of the vehicle 10 which coasts at the time of forward travel, by switching the mode switching clutch SOWC to the lock mode, rotation transmitted from the driving wheels 14 is transmitted to the engine 12 via the mode switching clutch SOWC and thus engine brake based on corotation with the engine 12 can be generated. Accordingly, in the state in which the mode switching clutch SOWC is in the lock mode, the first strut 72a and the second strut 72b function as one-way clutches and power is transmitted in the driving state and the driven state of the vehicle 10.

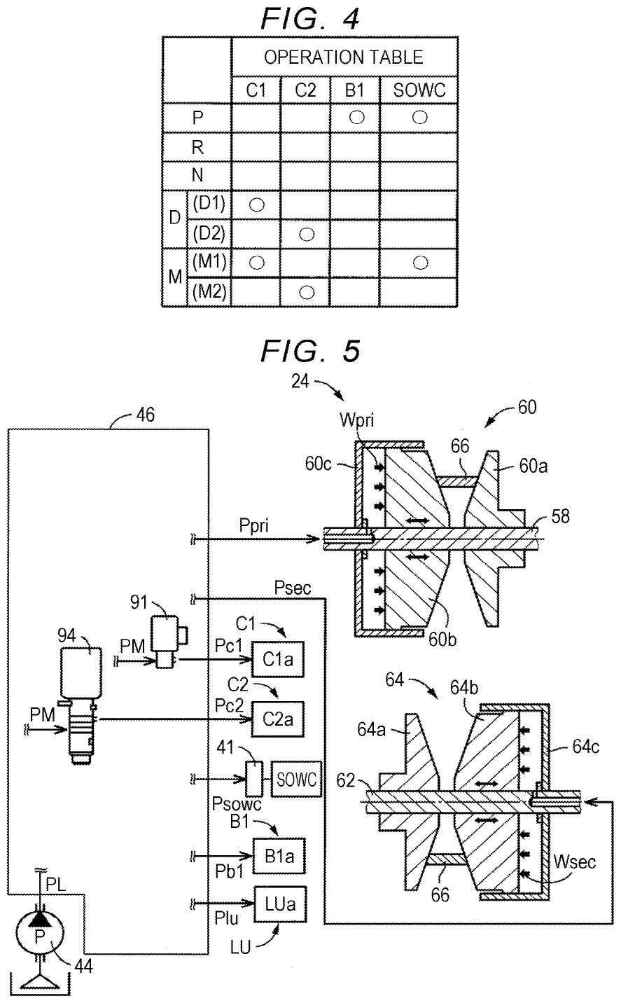

FIG. 4 is an engagement operation table illustrating engagement states of the engagement devices for each operating position POSsh which is selected by a shift lever 98 (see FIG. 1) which is provided in the vehicle 10. In FIG. 4, “C1” corresponds to the first clutch C1, “C2” corresponds to the second clutch C2, “B1” corresponds to the first brake B1, and “SOWC” corresponds to the mode switching clutch SOWC. “P (P position),” “R (R position),” “N (N position),” “D (D position),” and “M (M position)” indicate operating positions POSsh which are selected by the shift lever. In FIG. 4, “O” denotes engagement of each engagement device and a blank denotes disengagement thereof. In “SOWC” corresponding to the mode switching clutch SOWC, “O” denotes switching of the mode switching clutch SOWC to the lock mode, and a blank denotes switching of the mode switching clutch SOWC to the one-way mode.

For example, when the operating position POSsh of the shift lever is switched to the P position which is a vehicle-stop position or the N position which is a power transmission intercepting position, the first clutch C1, the second clutch C2, and the first brake B1 are disengaged as illustrated in FIG. 4. At this time, the vehicle is in a neutral state in which power is not transmitted via any of the first power transmission path PT1 and the second power transmission path PT2.

When the operating position POSsh of the shift lever is switched to the R position which is a reverse-travel position, the first brake B1 is engaged and the mode switching clutch SOWC is switched to the lock mode as illustrated in FIG. 4. When the first brake B1 is engaged, power operating in the reverse travel direction (the reverse rotation direction) is transmitted from the engine 12 to the gear mechanism 28. At this time, when the mode switching clutch SOWC is switched to the lock mode, power operating in the reverse travel direction is transmitted to the driving wheels 14 via the mode switching clutch SOWC and thus reverse travel is possible. Accordingly, when the operating position POSsh is switched to the R position, the first brake B1 is engaged and the mode switching clutch SOWC is switched to the lock mode, whereby a reverse gear stage in which power operating in the reverse travel direction is transmitted via the first power transmission path PT1 (the gear mechanism 28) is formed.

When the operating position POSsh of the shift lever is switched to the D position which is a forward-travel position, the first clutch C1 is engaged or the second clutch C2 is engaged as illustrated in FIG. 4. “D1 (D1 position)” and “D2 (D2 position)” in FIG. 4 are virtual operating positions which are set for control. When the operating position POSsh is switched to the D position, the operating position is automatically switched to the D1 position or the D2 position depending on the travel state of the vehicle 10. The D1 position is set in a relatively low-speed area including a vehicle-stop area. The D2 position is set in a relatively high-speed area including a middle-speed area. For example, when the travel state of the vehicle 10 shifts from a low-speed area to a high-speed area during travel at the D position, the operating position is automatically switched from the D1 position to the D2 position.

For example, when the operating position POSsh is switched to the D position and the travel state of the vehicle 10 is in a travel area corresponding to the D1 position, the first clutch C1 is engaged and the second clutch C2 is disengaged. At this time, a gear travel mode in which power operating in the forward travel direction is transmitted from the engine 12 to the driving wheels 14 via the first power transmission path PT1 (the gear mechanism 28) is set. Since the mode switching clutch SOWC is switched to the one-way mode, the mode switching clutch SOWC can transmit power operating in the forward travel direction.

For example, when the operating position POSsh is switched to the D position and the travel state of the vehicle 10 is in a travel area corresponding to the D2 position, the first clutch C1 is disengaged and the second clutch C2 is engaged. At this time, a belt travel mode in which power operating in the forward travel direction is transmitted from the engine 12 to the driving wheels 14 via the second power transmission path PT2 (the stepless gear shifting mechanism 24) is set. In this way, when the operating position POSsh is switched to the D position, the power of the engine 12 is transmitted to the driving wheels 14 via the first power transmission path PT1 (the gear mechanism 28) or the second power transmission path PT2 (the stepless gear shifting mechanism 24) depending on the travel state of the vehicle 10.

When the operating position POSsh of the shift lever is switched to the M position, switching between upshift and downshift by a driver's manual operation is possible. That is, the M position is a manual shift position at which gear shifting can be performed by a driver's manual operation. For example, when the operating position POSsh is switched to the M position and downshift is manually performed by a driver during travel at the M2 position as illustrated in FIG. 4, the operation position is switched to the M1 position in FIG. 4, and a forward-travel gear stage in which the first clutch C1 is engaged in the state in which the second clutch C2 is engaged and the mode switching clutch SOWC is set to the lock mode is formed.

When the mode switching clutch SOWC is switched to the lock mode, the mode switching clutch SOWC can transmit power in both the driving state and the driven state of the vehicle 10. That is, the mode switching clutch SOWC can transmit power operating in the forward travel direction (the forward rotation direction) and the reverse travel direction (the reverse rotation direction). For example, during coasting, the driven state in which rotation of the driving wheels 14 is transmitted is set, but when downshift is manually performed at the M position at this time, rotation from the driving wheels 14 is transmitted to the engine 12 via the mode switching clutch SOWC and thus engine brake due to corotation of the engine 12 can be generated. In this way, when the operating position POSsh is downshifted at the M position, rotation from the driving wheels 14 is transmitted to the engine 12 via the first power transmission path PT1 during coasting, and thus a forward-travel gear stage in which engine brake can be generated is formed.

When the operating position POSsh of the shift lever is switched to the M position and is manually operated to an upshift side by a driver during travel at the M1 position in FIG. 4, the operating position is switched to the M2 position in FIG. 4 and the second clutch C2 is engaged. At this time, a forward-travel stepless gear stage in which power is transmitted to the driving wheels 14 via the second power transmission path PT2 (the stepless gear shifting mechanism 24) is formed.

In this way, when the operating position POSsh is switched to the M position, manual shift of switching to one of the forward-travel gear stages (that is, the gear travel mode) in which power is transmitted via the first power transmission path PT1 and the forward-travel stepless gear stage (that is, the belt travel mode) in which power is transmitted via the second power transmission path PT2 can be performed by a driver's manual operation. The case in which the operating position POSsh is downshifted at the M position corresponds to the M1 position in FIG. 4, and the case in which the operating position POSsh is upshifted at the M position corresponds to the M2 position in FIG. 4. The M1 position and the M2 position are virtual positions which are set in view of control and are not apparently provided.

FIG. 5 is a diagram schematically illustrating the hydraulic pressure control circuit 46 that controls the operation state of the transmission 39 illustrated in FIG. 1. In FIG. 5, the primary pulley 60 constituting the stepless gear shifting mechanism 24 includes a fixed sheave 60a that is fixed to the primary shaft 58, a movable sheave 60b that is provided to be non-rotatable relative to the primary shaft 58 and to be movable in the axial direction relative thereto, and a hydraulic actuator 60c that applies a primary thrust Wpri to the movable sheave 60b. The primary thrust Wpri is a thrust (=primary pressure Ppri×pressure-receiving area) of the primary pulley 60 for changing a V-groove width between the fixed sheave 60a and the movable sheave 60b. The primary pressure Ppri is a hydraulic pressure of a hydraulic oil which is supplied to the hydraulic actuator 60c by the hydraulic pressure control circuit 46.

The second pulley 64 includes a fixed sheave 64a that is fixed to the secondary shaft 62, a movable sheave 64b that is provided to be non-rotatable relative to the secondary shaft 62 and to be movable in the axial direction relative thereto, and a hydraulic actuator 64c that applies a thrust Wsec to the movable sheave 64b. The secondary thrust Wsec is a secondary thrust (=secondary pressure Psec pressure-receiving area) of the second pulley 64 for changing a V-groove width between the fixed sheave 64a and the movable sheave 64b. The secondary pressure Psec is a hydraulic pressure of a hydraulic oil which is supplied to the hydraulic actuator 64c by the hydraulic pressure control circuit 46.

In the stepless gear shifting mechanism 24, the primary thrust Wpri and the secondary thrust Wsec are controlled by controlling the primary pressure Ppri and the secondary pressure Psec using the hydraulic pressure control circuit 46. Accordingly, in the stepless gear shifting mechanism 24, the V-groove widths of the pulleys 60 and 64 change, a suspended diameter (=effective diameter) of the transmission belt 66 is changed, a gear ratio γcvt (=primary rotation speed Npri/secondary rotation speed Nsec) is changed, and the belt clamping force is controlled such that the transmission belt 66 does not slip. That is, by controlling the primary thrust Wpri and the secondary thrust Wsec, belt slippage which is slippage of the transmission belt 66 is prevented and the gear ratio γcvt of the stepless gear shifting mechanism 24 is changed to a target gear ratio γcvttgt. The target gear ratio γcvttgt is a target value which is set from time to time based on a vehicle speed V, an accelerator opening θacc, and the like. The primary rotation speed Npri is a rotation speed of the primary shaft 58, the input shaft 22, and the primary pulley 60, and the secondary rotation speed Nsec is a rotation speed of the secondary shaft 62 and the second pulley 64.

The hydraulic pressure control circuit 46 includes a plurality of solenoid valves (electromagnetic valves) and a plurality of control valves. The plurality of solenoid valves includes an on-off solenoid valve 91 that controls a C1 clutch pressure Pc1 which is a supply hydraulic pressure of a hydraulic actuator C1a of the first clutch C1 and a linear solenoid valve 94 that controls a C2 clutch pressure Pc2 which is a supply hydraulic pressure of a hydraulic actuator C2a of the second clutch C2. The on-off solenoid valve 91 and the linear solenoid valve 94 are known and thus detailed description thereof will be omitted.

Although not illustrated in FIG. 5, the hydraulic pressure control circuit 46 includes a plurality of solenoid valves that directly or indirectly controls a B1 control pressure Pb1 which is a supply hydraulic pressure which is supplied to a hydraulic actuator B1a of the first brake B1, a mode switching hydraulic pressure Psowc which is a supply hydraulic pressure which is supplied to the hydraulic actuator 41 for switching the mode of the mode switching clutch SOWC, a primary pressure Ppri which is supplied to the a hydraulic actuator 60c of the primary pulley 60, a secondary pressure Psec which is supplied to a hydraulic actuator 64c of the second pulley 64, and an LU pressure Plu for controlling a lock-up clutch LU. In this embodiment, all the solenoid valves that control these hydraulic pressures are formed of linear solenoid valves.

Referring back to FIG. 1, the vehicle 10 includes an electronic control unit 100 which is a controller including a control device for the transmission 39. The electronic control unit 100 is constituted by, for example, a so-called microcomputer including a CPU, a RAM, a ROM, and an input/output interface and performs various types of control of the vehicle 10 by causing the CPU to perform signal processing in accordance with a program which is stored in the ROM in advance while using a temporary storage function of the RAM. The electronic control unit 100 performs output control of the engine 12, gear shifting control or belt clamping pressure control of the stepless gear shifting mechanism 24, hydraulic pressure control for switching operating states of the plurality of engagement devices (C1, B1, C2, and SOWC), and the like. The electronic control unit 100 is divisionally configured for engine control, hydraulic pressure control, and the like according to necessity.

The electronic control unit 100 is supplied with various detection signals (for example, an engine rotation speed Ne, a primary rotation speed Npri which is the same value as the input-shaft rotation speed Nin, a secondary rotation speed Nsec, an output-shaft rotation speed Nout corresponding to the vehicle speed V, an input-side rotation speed Nsoin of the input-side rotary member 68 constituting the mode switching clutch SOWC, an accelerator opening θacc indicating an amount of operation of an accelerator pedal 45 by a driver, a throttle valve opening θth, an operating position POSsh of the shift lever 98 which is a shift switching device provided in the vehicle 10, a hydraulic oil temperature THoil which is the temperature of a hydraulic oil in the hydraulic pressure control circuit 46, and acceleration/deceleration G of the vehicle 10) from various sensors (for example, various rotation speed sensors 102, 104, 106, 108, and 109, an accelerator opening sensor 110, a throttle valve opening sensor 112, a shift position sensor 114, an oil temperature sensor 116, and an acceleration sensor 118) provided in the vehicle 10. The input-shaft rotation speed Nin (=primary rotation speed Npri) is also a turbine rotation speed NT. The electronic control unit 100 calculates a gear ratio γcvt (=Npri/Nsec) which is an actual gear ratio of the stepless gear shifting mechanism 24 from time to time based on the primary rotation speed Npri and the secondary rotation speed Nsec. The electronic control unit 100 calculates the output-side rotation speed Nsoout of the first output-side rotary member 70a and the second output-side rotary member 70b (hereinafter referred to as an output-side rotary member 70 when not distinguished from each other) constituting the mode switching clutch SOWC from time to time based on the output-shaft rotation speed Nout.

The electronic control unit 100 outputs various command signals (for example, an engine control command signal Se for controlling the engine 12, a hydraulic pressure control command signal Scvt for controlling gear shifting, the belt clamping pressure, or the like of the stepless gear shifting mechanism 24, and a hydraulic pressure control command signal Scbd for controlling the operating states of the plurality of engagement devices) to various devices (for example, the engine control device 42 and the hydraulic pressure control circuit 46) provided in the vehicle 10.

In response to the hydraulic pressure control command signal Scvt and the hydraulic pressure control command signals Scbd, the hydraulic pressure control circuit 46 outputs the C1 clutch pressure Pc1 which is the supply hydraulic pressure which is supplied to the hydraulic actuator C1a of the first clutch C1, the B1 brake pressure Pb1 which is the supply hydraulic pressure which is supplied to the hydraulic actuator B1a of the first brake B1, the C2 clutch pressure Pc2 which is the supply hydraulic pressure which is supplied to the hydraulic actuator C2a of the second clutch C2, the mode switching hydraulic pressure Psowc which is the supply hydraulic pressure which is supplied to the hydraulic actuator 41 for switching the mode of the mode switching clutch SOWC, the primary pressure Ppri which is supplied to the hydraulic actuator 60c of the primary pulley 60, the secondary pressure Psec which is supplied to the hydraulic actuator 64c of the second pulley 64, and the like.

In order to realize various controls in the vehicle 10, the electronic control unit 100 functionally includes an engine control unit 120 that functions as an engine control means that controls the output of the engine 12, a stepless gear shifting control unit 122 that functions as a stepless gear shifting control means that performs stepless gear shifting control of the stepless gear shifting mechanism 24, and a switching control unit 124 that functions as a switching control means that performs switching control of the power transmission path PT between the first power transmission path PT1 and the second power transmission path PT2.

The engine control unit 120 calculates required drive power Fdem by applying drive power relevant values such as the accelerator opening θacc and the vehicle speed V to a drive power map which is a relationship which is acquired and stored in advance by experiment or design. The engine control unit 120 sets a target engine torque Tetgt at which the required drive power Fdem is acquired and outputs a command for controlling the engine 12 such that the target engine torque Tetgt is acquired to the engine control device 42.

The stepless gear shifting control unit 122 outputs a command for controlling the gear ratio γcvt of the stepless gear shifting mechanism 24 such that it reaches the target gear ratio γcvttgt which is calculated based on the accelerator opening θacc, the vehicle speed V, and the like during travel in the belt travel mode in which power is transmitted to the hydraulic pressure control circuit 46 via the second power transmission path PT2. While adjusting the belt clamping pressure of the stepless gear shifting mechanism 24 to an optimal value, the stepless gear shifting control unit 122 stores a predetermined relationship (for example, a gear shifting map) for achieving the target gear ratio γcvttgt of the stepless gear shifting mechanism 24 at which the operating point of the engine 12 is in a predetermined optimal line (for example, an optimal engine fuel efficiency line), determines an instructed primary pressure Ppritgt which is a command value of the primary pressure Ppri which is supplied to the hydraulic actuator 60c of the primary pulley 60 and an instructed secondary pressure Psectgt which is a command value of the secondary pressure Psec which is supplied to the hydraulic actuator 64c of the second pulley 64 from the relationship based on the accelerator opening θacc, the vehicle speed V, and the like, outputs a command for controlling the primary pressure Ppri and the secondary pressure Psec such that the instructed primary pressure Ppritgt and the instructed secondary pressure Psectgt are achieved to the hydraulic pressure control circuit 46, and performs gear shifting of the stepless gear shifting mechanism 24. The gear shifting control of the stepless gear shifting mechanism 24 is known and thus detailed description thereof will be omitted.

When the operating position POSsh is the D position, the switching control unit 124 performs switching control for switching the travel mode between the gear traveling mode in which the power of the engine 12 is transmitted to the driving wheels 14 via the first power transmission path PT1 and the belt travel mode in which the power of the engine 12 is transmitted to the driving wheels 14 via the second power transmission path PT2. That is, the switching control unit 124 performs switching control for switching the power transmission path PT between the first power transmission path PT1 and the second power transmission path PT2.

The switching control unit 124 stores a switching map which is a predetermined relationship for switching the travel mode between the gear travel mode and the belt travel mode. The switching map is constituted by the vehicle speed V, the accelerator opening θacc, and the like, and an upshift line for determining switching from the gear travel mode to the belt travel mode and a downshift line for determining switching from the belt travel mode to the gear travel mode are set in the switching map.

The switching control unit 124 determines whether switching is necessary by applying the actual vehicle speed V and the actual accelerator opening θacc to the switching map and performs switching of the travel mode based on the result of determination. For example, switching to the gear travel mode (downshift) is determined when the downshift line is crossed during travel in the belt travel mode, and switching to the belt travel mode (upshift) is determined whether the upshift line is crossed during travel in the gear travel mode. The gear travel mode corresponds to the D1 position in FIG. 4 and the belt travel mode corresponds to the D2 position in FIG. 4.

For example, when a switching request (an upshift request) for switching to the belt travel mode (corresponding to the D2 position in FIG. 4) is satisfied during travel in the gear travel mode (corresponding to the D1 position in FIG. 4) in a state in which the operating position POSsh is the D position, the switching control unit 124 outputs a command for disengaging the first clutch C1 and engaging the second clutch C2 to the hydraulic pressure control circuit 46. Accordingly, the power transmission path PT in the transmission 39 is switched from the first power transmission path PT1 to the second power transmission path PT2. When a switching request (a downshift request) for switching to the gear travel mode is satisfied during travel in the belt travel mode in a state in which the operating position POSsh is the D position, the switching control unit 124 outputs a command for disengaging the second clutch C2 and engaging the first clutch C1 to the hydraulic pressure control circuit 46. Accordingly, the power transmission path PT in the transmission 39 is switched from the second power transmission path PT2 to the first power transmission path PT1.

As described above, when switching to the gear travel mode is performed during travel in the belt travel mode, the second clutch C2 is disengaged and the first clutch C1 is engaged in the transition period of switching. At this time, in the transition period of switching of the power transmission path PT, there is temporarily a state in which both the first clutch C1 and the second clutch C2 have a torque capacity, but since transmission of power via the mode switching clutch SOWC is intercepted in the first power transmission path PT1, simultaneous transmission of power to the first power transmission path PT1 and the second power transmission path PT2 is curbed.

However, when an abnormality in which the mode switching clutch SOWC is secured to the lock mode occurs, that is, when an abnormality in which the mode switching clutch SOWC is secured to a state in which power operating in two directions is transmitted occurs, and the travel mode is switched from the belt travel mode to the gear travel mode in this state, there is concern about occurrence of a shock because power is transmitted via both the first power transmission path PT1 and the second power transmission path PT2 in a state in which both the first clutch C1 and the second clutch C2 have a torque capacity in the transition period of switching.

When the travel mode is switched from the gear travel mode to the belt travel mode, there is temporarily a state in which both the first clutch C1 and the second clutch C2 have a torque capacity in the transition period of switching. At this time, when an abnormality in which the mode switching clutch SOWC is secured to the lock mode occurs, there is concern about occurrence of a shock because power is transmitted via both the first power transmission path PT1 and the second power transmission path PT2 in a state in which both the first clutch C1 and the second clutch C2 have a torque capacity in the transition period of switching.

In order to solve this problem, the electronic control unit 100 functionally includes a clutch abnormality handling unit 126 that functions as a clutch abnormality handling means that can curb a shock due to switching of the travel mode even when an abnormality in which the mode switching clutch SOWC is secured to the lock mode occurs.

The clutch abnormality handling unit 126 determines whether the vehicle is traveling in the belt travel mode, and prohibits switching to the gear travel mode when a rotation speed difference ΔNsowc between rotary elements before and after the mode switching clutch SOWC becomes equal to or less than a predetermined value α1 during travel in the belt travel mode even when it is determined that the travel mode is switched to the gear travel mode. Here, the rotation speed difference ΔN between rotary members before and after the mode switching clutch SOWC corresponds to a difference (=|Nsoin−Nsoout|) between the input-side rotation speed Nsoin of the input-side rotary member 68 and the output-side rotation speed Nsoout of the output-side rotary member 70 which constitute the mode switching clutch SOWC. The belt travel mode corresponds to a travel mode in which power of a drive source is transmitted to the driving wheels via the second power transmission path in the claims, and the gear travel mode corresponds to a travel mode in which power of the drive source is transmitted to the driving wheels via the first power transmission path in the claims.

The clutch abnormality handling unit 126 calculates the rotation speed difference ΔNsowc between the rotary elements of the mode switching clutch SOWC from time to time during travel in the belt travel mode and determines whether the rotation speed difference ΔNsowc is equal to or less than the predetermined value α1. Since the first clutch C1 is disengaged during travel in the belt travel mode, rotation from the engine 12 is not transmitted to the input-side rotary member 68. That is, the input-side rotation speed Nsoin becomes zero or a very low rotation speed due to a drag in the first clutch C1. On the other hand, the output-side rotation speed Nsoout of the output-side rotary member 70 becomes a rotation speed corresponding to the vehicle speed V. Accordingly, when the mode switching clutch SOWC is normal, the rotation speed difference ΔNsowc becomes substantially the same as the output-side rotation speed Nsoout. On the other hand, when the mode switching clutch SOWC is secured to the lock mode, the rotation of the output-side rotary member 70 is transmitted to the input-side rotary member 68 and thus the rotation speed difference ΔNsowc becomes zero or substantially zero. Accordingly, when the predetermined value α1 is set to a very low rotation speed in the vicinity of zero and the rotation speed difference ΔNsowc is equal to or less than the predetermined value α1, it is determined that an abnormality in which the mode switching clutch SOWC is secured to the lock mode occurs.

When the rotation speed difference ΔNsowc becomes equal to or less than the predetermined value α1 during travel in the belt travel mode, the clutch abnormality handling unit 126 prohibits switching to the gear travel mode even when it is determined that switching to the gear travel mode is to be performed based on the switching map. Since switching to the gear travel mode is prohibited, a shock which occurs due to simultaneous transmission of power to the first power transmission path PT1 and the second power transmission path PT2 in the transition period of switching to the gear travel mode is curbed.

The clutch abnormality handling unit 126 determines that the transition period of switching from the gear travel mode to the belt travel mode comes in and disengages the first clutch C1 when an amount of change of the input-shaft rotation speed Nin of the input shaft 22 of the transmission 39 with the progress of switching is equal to or less than a predetermined value α3 which will be described later in the transition period of switching from the gear travel mode to the belt travel mode.

When it is determined that switching from the gear travel mode to the belt travel mode is to be performed during travel and the mode switching clutch SOWC is in the lock mode, the switching control unit 124 rapidly switches the mode switching clutch SOWC to the one-way mode and then starts switching control. Accordingly, when the travel mode is switched from the gear travel mode to the belt travel mode, the switching control is started in the state in which the mode switching clutch SOWC is switched to the one-way mode.

The switching control unit 124 starts engagement of the second clutch C2 in a state in which the first clutch C1 is engaged in the transition period of switching from the gear travel mode to the belt travel mode. Then, when the torque capacity Tc2 of the second clutch C2 reaches a value in which power from the engine 12 can be transmitted, the mode switching clutch SOWC is intercepted and switched to transmission of power via the second power transmission path PT2, and an inertia phase based on the power transmission path PT of the transmission 39 is started. On the other hand, when an abnormality in which the mode switching clutch SOWC is secured to the lock mode occurs in the transition period of switching, the first power transmission path PT1 is maintained in a power-transmittable state even when the torque capacity of the second clutch C2 reaches the value in which power from the engine 12 can be transmitted, thus the progress of switching is hindered, and the inertia phase is not started.

Therefore, when a condition (hereinafter, a rotation change start condition) in which the inertia phase of the transmission 39 is started is satisfied in the transition period of switching from the gear travel mode to the belt travel mode, the clutch abnormality handling unit 126 determines whether the amount of change of the input-shaft rotation speed Nin due to the switching is equal to or less than the predetermined value α3, that is, whether the inertia phase is not started, and disengages the first clutch C1 when the amount of change of the input-shaft rotation speed Nin is equal to or less than the predetermined value α3 (that is, when the inertia phase is not started). When the rotation change start condition is satisfied but change in rotation of the input-shaft rotation speed Nin does not occur (when the inertia phase is not started) in the transition period of switching from the gear travel mode to the belt travel mode, there is concern about the mode switching clutch SOWC being secured to the lock mode. In this case, since the first clutch C1 is disengaged and thus the transmission of power via the first power transmission path PT1 is intercepted even when the mode switching clutch SOWC is secured to the lock mode, occurrence of a shock due to simultaneous transmission of power via the first power transmission path PT1 and the second power transmission path PT2 is curbed.

Here, whether the rotation change start condition is satisfied is determined based on whether an estimated torque capacity Tc2est which is an estimated value of a torque capacity Tc2 of the second clutch C2 is equal to or greater than the predetermined value α2 at which the inertia phase is started. The predetermined value α2 is set to the torque capacity Tc2 which is acquired in advance by experiment or design and at which the inertia phase is started in the transmission 39. The torque capacity Tc2 of the second clutch C2 at which the inertia phase is started changes depending on the engine torque Te of the engine 12 or the like. Accordingly, a relation map for acquiring the predetermined value α2, which is constituted by the engine torque Te or the like is acquired and stored in advance, and the predetermined value α2 is determined by applying a relevant value of the predetermined value α2 such as the engine torque Te to the relation map.

The clutch abnormality handling unit 126 determines the predetermined value α2, estimates the estimated torque capacity Tc2est which is an estimated value of the torque capacity Tc2 of the second clutch C2, and determines whether the estimated torque capacity Tc2est is equal to or greater than the predetermined value α2. The estimated torque capacity Tc2est is acquired based on an estimation map of the torque capacity Tc2 which is constituted by an instructed pressure Pc2* of the second clutch C2, a hydraulic oil temperature THoil of a hydraulic oil, and the like. The method of estimating the estimated torque capacity Tc2est is known and thus description thereof will be omitted.

When the estimated torque capacity Tc2est is equal to or greater than the predetermined value α2, that is, when the rotation change start condition is satisfied, the clutch abnormality handling unit 126 determines whether the inertia phase is not started based on whether the amount of change of the input-shaft rotation speed Nin of the input shaft 22 is equal to or less than the predetermined value α3. The clutch abnormality handling unit 126 calculates a difference ΔNin(=|Nin−Nins|) between the input-shaft rotation speed Nin of the input shaft 22 of the transmission 39 and a pre-switching input-shaft rotation speed Nins which is calculated from a pre-switching gear ratio EL and the output-shaft rotation speed Nout. This difference ΔNin corresponds to the amount of change of the input-shaft rotation speed Nin.

Subsequently, the clutch abnormality handling unit 126 determines whether the calculated difference ΔNin is equal to or less than the predetermined value α3. The predetermined value α3 is set to a value of a low rotation speed at which change of rotation of the input-shaft rotation speed Nin does not occur, that is, at which it can be determined that the inertia phase is not started. Accordingly, when the difference ΔNin is equal to or less than the predetermined value α3, it is determined that the inertia phase is not started. That is, even when the rotation change start condition is satisfied, it is determined that change of the input-shaft rotation speed Nin due to the progress of switching does not occur. At this time, the clutch abnormality handling unit 126 disengages the first clutch C1 to intercept transmission of power via the first power transmission path PT1, and a shock due to simultaneous transmission of power via the first power transmission path PT1 and the second power transmission path PT2 is curbed. By intercepting the first power transmission path PT1, the inertia phase is started and switching to the second power transmission path PT2 becomes possible.

When an elapsed time t from a switching start time point is greater than a predetermined time t1, it may be determined whether the inertia phase is not started based on whether an amount of change of the input-shaft rotation speed Nin of the input shaft 22 is equal to or less than the predetermined value α3. Here, the predetermined time t1 is acquired in advance by experiment or design, and the torque capacity Tc2 of the second clutch C2 is set to a value which is equal to or greater than the predetermined value α2 at which the inertia phase is started. That is, when the elapsed time t reaches the predetermined time t1, it is determined that the rotation change start condition is satisfied. Since the predetermined time t1 changes depending on the engine torque Te or the like, a relation map for acquiring the predetermined time t1 which is constituted by the engine torque Te and the like is acquired and stored in advance and the predetermined time t1 is determined from time to time by applying the engine torque Te and the like to the relation map.

When the elapsed time t from the switching start time point reaches the predetermined time t1, the clutch abnormality handling unit 126 determines whether the inertia phase is not started based on whether the difference ΔNin(=|Nin−Nins|) between the input-shaft rotation speed Nin of the input shaft 22 of the transmission 39 and a pre-switching input-shaft rotation speed Nins which is calculated from a pre-switching gear ratio EL and the output-shaft rotation speed Nout is equal to or less than the predetermined value α3. When the difference ΔNin is equal to or less than the predetermined value α3, that is, when the rotation change start condition is satisfied but the inertia phase is not started, the clutch abnormality handling unit 126 disengages the first clutch C1. In this way, whether the rotation change start condition is satisfied may be determined based on the elapsed time t.

When the elapsed time t from the switching start time point becomes greater than a predetermined time t2 which is set in advance in the transition period of switching from the gear travel mode to the belt travel mode, whether the amount of change of the input-shaft rotation speed Nin of the input shaft 22 due to the progress of switching is equal to or less than a predetermined value may be determined based on whether the input-shaft rotation speed Nin of the input shaft 22 has reached a synchronous rotation speed Nsync which is set after the switching. Here, the predetermined time t2 is acquired in advance by experiment or design and is set to a value in which the input-shaft rotation speed Nin reaches the synchronous rotation speed Nsync after the switching when the mode switching clutch SOWC is normal. That is, the predetermined time t2 is set to a time in which the inertia phase with the progress of switching of the power transmission path PT ends. The synchronous rotation speed Nsync is calculated based on a product (=Nout×γmax) of the output-shaft rotation speed Nout and the gear ratio γcvt (the lowest gear ratio γmax) of the stepless gear shifting mechanism 24 which is set after the switching.

When the elapsed time t from the switching start time point becomes greater than the predetermined time t2, the clutch abnormality handling unit 126 determines whether the difference ΔNsync (=|Nsync−Nin|) between the input-shaft rotation speed Nin and the synchronous rotation speed Nsync is greater than a predetermined value α4 which is set in advance. The predetermined value α4 is set to a low rotation speed value at which it can be determined that the input-shaft rotation speed Nin has reached the synchronous rotation speed Nsync when the difference ΔNsync is equal to or less than the predetermined value α4. When the difference ΔNsync is greater than the predetermined value α4, that is, when the input-shaft rotation speed Nin has not reached the synchronous rotation speed Nsync, the clutch abnormality handling unit 126 disengages the first clutch C1. The case in which the input-shaft rotation speed Nin has not reached the synchronous rotation speed Nsync even after the predetermined time t2 has elapsed is an example of a case in which the input-shaft rotation speed Nin of the input shaft 22 is equal to or less than the predetermined value due to the progress of switching.

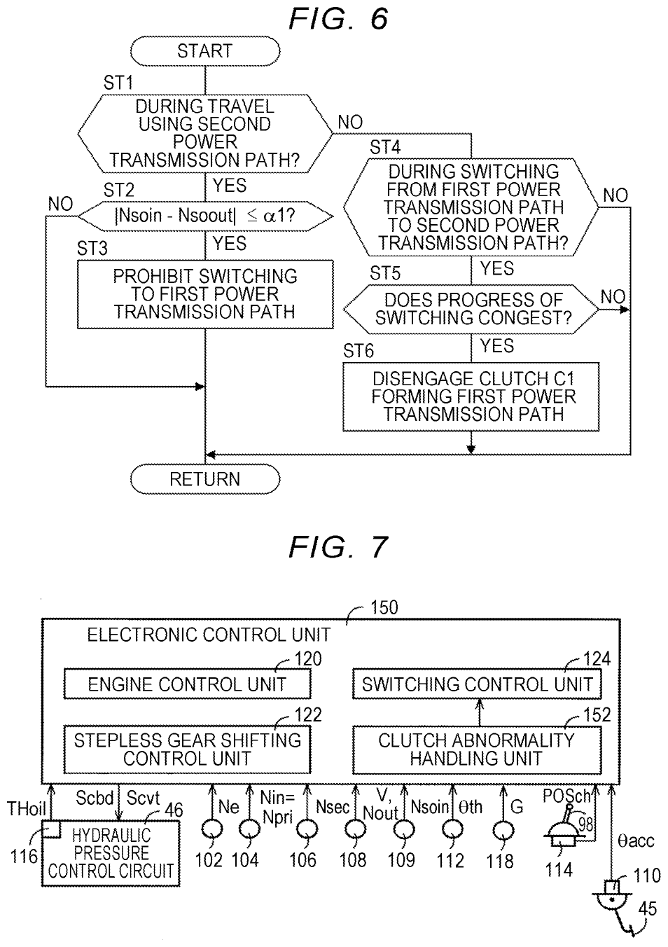

FIG. 6 is a flowchart illustrating a principal part of a control operation which is performed by the electronic control unit 100 and which is used to curb occurrence of a shock when power is simultaneously transmitted via the first power transmission path PT1 and the second power transmission path PT2. This flowchart is repeatedly performed during travel of the vehicle.

First, in Step ST1 (the word “step” is omitted below) corresponding to the control function of the clutch abnormality handling unit 126, it is determined whether the vehicle is traveling in the belt travel mode in which power is transmitted via the second power transmission path PT2. When the determination result of ST1 is positive, it is determined whether the rotation speed difference ΔNsowc between the rotary members before and after the mode switching clutch SOWC is equal to or less than the predetermined value α1 in ST2 corresponding to the control function of the clutch abnormality handling unit 126. When the determination result of ST2 is negative, it is determined that the mode switching clutch SOWC operates normally and the process flow restarts. When the determination result of ST2 is positive, there is a likelihood that the mode switching clutch SOWC is secured to the lock mode and thus switching to the gear travel mode in which power is transmitted via the first power transmission path PT1 is prohibited in ST3 corresponding to the control function of the clutch abnormality handling unit 126. Accordingly, a shock due to simultaneous transmission of power via the first power transmission path PT1 and the second power transmission path PT2 by switching to the gear travel mode is curbed.

The process flow returns to ST1, and when the determination result of ST1 is negative, it is determined whether the travel mode is being switched from the gear travel mode to the belt travel mode, that is, whether the travel mode is being switched from the first power transmission path PT1 to the second power transmission path PT2, in ST4 corresponding to the control function of the clutch abnormality handling unit 126. When the determination result of ST4 is negative, the process flow returns. When the determination result of ST4 is positive, it is determined whether the progress of switching is congested, specifically, whether the input-shaft rotation speed Nin does not change even when the rotation change start condition is satisfied, in ST5 corresponding to the control function of the clutch abnormality handling unit 126. When the determination result of ST5 is negative, the process flow returns. On the other hand, when the determination result of ST5 is positive, the first clutch C1 constituting the first power transmission path PT1 is disengaged in ST6 corresponding to the control function of the clutch abnormality handling unit 126. Accordingly, since transmission of power via the first power transmission path PT1 is intercepted, switching to the belt travel mode progresses and a shock due to simultaneous transmission of power via the first power transmission path PT1 and the second power transmission path PT2 is curbed.

According to the embodiment described above, when the rotation speed difference ΔNsowc between the rotary members of the mode switching clutch SOWC is equal to or less than the predetermined value α1 during travel in the belt travel mode, there is a likelihood that the mode switching clutch SOWC is secured to the lock mode in which power operating in two directions is transmitted. At this time, since switching to the gear travel mode is prohibited, it is possible to curb occurrence of a shock when the power is simultaneously transmitted via the first power transmission path PT1 and the second power transmission path PT2 in the transition period of switching to the gear travel mode.

According to this embodiment, when change in rotation of the input-shaft rotation speed Nin with the progress of switching does not occur in the transition period of switching from the gear travel mode to the belt travel mode, there is a likelihood that the mode switching clutch SOWC would be secured to the lock mode in which power operating in two directions is transmitted. On the other hand, since the first clutch C1 is disengaged when the amount of change of the input-shaft rotation speed Nin of the input shaft 22 with the progress of switching is equal to or less than the predetermined value α3, it is possible to curb occurrence of a shock when the power is simultaneously transmitted via the first power transmission path PT1 and the second power transmission path PT2 in the transition period of switching.

Another embodiment of the present disclosure will be described below. In the following description, elements which are common to the above embodiment will be referred to by the same reference signs and description thereof will be omitted.

FIG. 7 is a functional block diagram illustrating a control function of an electronic control unit 150 according to another embodiment of the present disclosure. The structure of a vehicle 10 is the same as in the above embodiment and thus is omitted.

The electronic control unit 150 functionally includes an engine control unit 120, a stepless gear shifting control unit 122, a switching control unit 124, and a clutch abnormality handling unit 152. The engine control unit 120, the stepless gear shifting control unit 122, and the switching control unit 124 have the same functions as in the above embodiment and thus description thereof will be omitted.

The clutch abnormality handling unit 152 prohibits switching to the gear travel mode when the rotation speed difference ΔNsowc before and after the mode switching clutch SOWC becomes equal to or less than the predetermined value α1 during travel in the belt travel mode as described above in the embodiment.

When deceleration G of the vehicle 10 in the transition period of switching from the gear travel mode to the belt travel mode is equal to or greater than a predetermined value α5, the clutch abnormality handling unit 152 disengages the first clutch C1. Specifically, the clutch abnormality handling unit 152 disengages the first clutch C1 when the deceleration G of the vehicle 10 is greater than the predetermined value α5 after the estimated torque capacity Tc2est which is an estimated value of the torque capacity Tc2 of the second clutch C2 constituting the second power transmission path PT2 has reached the predetermined value α2 at which the inertia phase is started.

When the mode switching clutch SOWC is secured to the lock mode, a force for hindering rotation acts on the rotary members constituting the transmission 39 and the deceleration G of the vehicle 10 increases as the torque capacity Tc2 of the second clutch C2 increases in the transition period of switching from the gear travel mode to the belt travel mode. Therefore, when the deceleration G of the vehicle 10 is greater than the predetermined value α5 in the transition period of switching, it is possible to curb a shock due to simultaneous transmission of power via the first power transmission path PT1 and the second power transmission path PT2 by disengaging the first clutch C1 to intercept transmission of power via the first power transmission path PT1.

Here, the predetermined value α5 is set to a value which is obtained by adding a correction value based on unevenness of components of the vehicle 10 or the like to a value corresponding to the deceleration G of the vehicle 10 which is generated based on a rate of increase (an increase gradient) of the torque capacity Tc2 of the second clutch C2 constituting the second power transmission path PT2. When the mode switching clutch SOWC is secured to the lock mode, a force acts in a direction in which the rotation of the transmission 39 is stopped and thus the deceleration G of the vehicle 10 becomes greater than the predetermined value α5. Accordingly, it is determined whether the mode switching clutch SOWC is secured to the lock mode based on whether the deceleration G of the vehicle 10 is greater than the predetermined value α5.

Since the deceleration G of the vehicle 10 in the transition period of switching also changes depending on the engine torque Te, the vehicle speed V, and the like, a relation map for acquiring the predetermined value α5 which is constituted by the engine torque Te, the vehicle speed V, and the like is acquired and stored in advance and the predetermined value α5 corresponding to a travel state is acquired by applying the engine torque Te, the vehicle speed V, and the like to the relation map.

When the estimated torque capacity Tc2est of the second clutch C2 reaches the predetermined value α2 at which the inertia phase is started in the transition period of switching from the gear travel mode to the belt travel mode, the clutch abnormality handling unit 152 determines whether the deceleration G of the vehicle 10 is greater than the predetermined value α5, and disengages the first clutch C1 when the deceleration G is greater than the predetermined value α5. Accordingly, since transmission of power via the first power transmission path PT1 is intercepted, it is possible to curb a shock due to simultaneous transmission of power via the first power transmission path PT1 and the second power transmission path PT2. The deceleration G of the vehicle 10 is directly detected by the acceleration sensor 118. Alternatively, the deceleration G of the vehicle 10 may be calculated based on the change of the vehicle speed V which is detected from time to time.

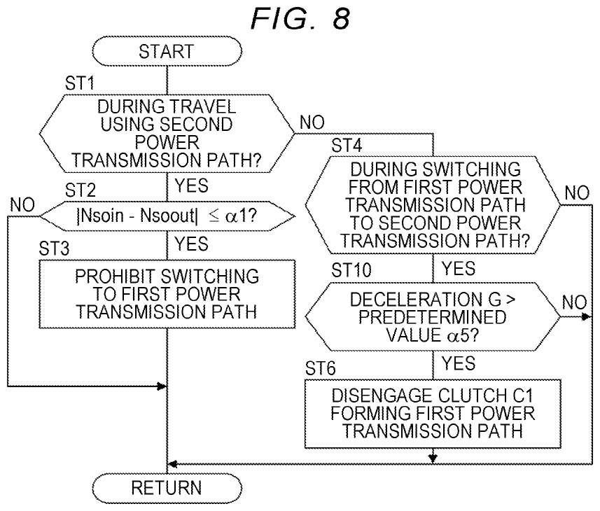

FIG. 8 is a flowchart illustrating a principal part of a control operation which is performed by the electronic control unit 150 and which is used to curb occurrence of a shock when power is simultaneously transmitted via the first power transmission path PT1 and the second power transmission path PT2. This flowchart is repeatedly performed during travel of the vehicle.

First, in Step ST1 (the word “step” is omitted below) corresponding to the control function of the clutch abnormality handling unit 152, it is determined whether the vehicle is traveling in the belt travel mode in which power is transmitted via the second power transmission path PT2. When the determination result of ST1 is positive, it is determined whether the rotation speed difference ΔNsowc between the rotary members before and after the mode switching clutch SOWC is equal to or less than the predetermined value α1 in ST2 corresponding to the control function of the clutch abnormality handling unit 152. When the determination result of ST2 is negative, it is determined that the mode switching clutch SOWC operates normally and the process flow restarts. When the determination result of ST2 is positive, there is a likelihood that the mode switching clutch SOWC is secured to the lock mode and thus switching to the gear travel mode in which power is transmitted via the first power transmission path PT1 is prohibited in ST3 corresponding to the control function of the clutch abnormality handling unit 152. Accordingly, a shock due to simultaneous transmission of power via the first power transmission path PT1 and the second power transmission path PT2 by switching to the gear travel mode is curbed.

The process flow returns to ST1, and when the determination result of ST1 is negative, it is determined whether the travel mode is being switched from the gear travel mode to the belt travel mode, that is, whether the travel mode is being switched from the first power transmission path PT1 to the second power transmission path PT2, in ST4 corresponding to the control function of the clutch abnormality handling unit 152. When the determination result of ST4 is negative, the process flow returns. When the determination result of ST4 is positive, it is determined whether the deceleration G of the vehicle 10 is greater than the predetermined value α5 in ST10 corresponding to the control function of the clutch abnormality handling unit 152. When the determination result of ST10 is negative, the process flow returns. On the other hand, when the determination result of ST10 is positive, the first clutch C1 constituting the first power transmission path PT1 is disengaged in ST6 corresponding to the control function of the clutch abnormality handling unit 152. Accordingly, since transmission of power via the first power transmission path PT1 is intercepted, switching to the belt travel mode progresses and a shock due to simultaneous transmission of power via the first power transmission path PT1 and the second power transmission path PT2 is curbed.

According to this embodiment described above, the same advantages as in the above embodiment are achieved. When the deceleration G of the vehicle 10 increases in the transition period of switching from the gear travel mode to the belt travel mode, there is a likelihood that the mode switching clutch SOWC would be secured to the state in which power operating in two directions is transmitted. On the other hand, since the first clutch C1 is disengaged when the deceleration G of the vehicle 10 is equal to or greater than the predetermined value α5 in the transition period of switching, it is possible to curb occurrence of a shock when the power is simultaneously transmitted via the first power transmission path PT1 and the second power transmission path PT2.

While embodiments of the present disclosure have been described above in detail with reference to the accompanying drawings, the present disclosure can be applied to other aspects.

For example, in the above embodiment, in the transition period of switching from the gear travel mode to the belt travel mode, whether the mode switching clutch SOWC is secured to the lock mode is indirectly determined based on whether change in rotation due to the switching does not occur even when the torque capacity Tc2 of the second clutch C2 reaches the predetermined value α2 at which the inertia phase is started or whether the deceleration G of the vehicle 10 in the transition period of switching to the belt travel mode is equal to or greater than the predetermined value α5. However, whether the mode switching clutch SOWC is secured to the lock mode may be determined using another method. For example, whether the mode switching clutch SOWC is secured to the lock mode may be indirectly determined based on whether slippage occurs between the primary pulley 60 and the second pulley 64 of the stepless gear shifting mechanism 24 and the transmission belt 66 in the transition period of switching from the gear travel mode to the belt travel mode.

When the mode switching clutch SOWC is secured to the lock mode and the torque capacity Tc2 of the second clutch C2 reaches the predetermined value α2 at which the inertia phase is started in the transition period of switching from the gear travel mode to the belt travel mode, slippage occurs due to simultaneous transmission of power via the first power transmission path PT1 and the second power transmission path PT2. Accordingly, it is possible to determine whether the mode switching clutch SOWC is secured to the lock mode by detecting occurrence of slippage in the transition period of switching. For example, whether slippage has occurred is determined based on whether the primary rotation speed Npri of the primary pulley 60 is greater than a value (=Nsec×γcvt) which is calculated as a product of the secondary rotation speed Nsec of the second pulley 64 and the gear ratio γcvt of the stepless gear shifting mechanism 24 (Npri>Nsec×γcvt), and the first clutch C1 is disengaged when slippage has occurred. In this way, even when whether the mode switching clutch SOWC is secured to the lock mode is determined based on occurrence of slippage in the transition period of switching from the gear travel mode to the belt travel mode, the same advantages as in the above embodiment are achieved.

In the above embodiments, the engine 12 is used as the drive source, but the applicable embodiment is not limited to the engine 12. For example, an electric motor may be used as the drive source or a hybrid type drive source including an engine and an electric motor may be used.

In the above embodiments, the stepless gear shifting mechanism 24 is a belt type stepless gear shifting mechanism, but the applicable embodiment is not limited to the belt type and a toroidal type stepless gear shifting mechanism or the like may be appropriately employed.

In the above embodiments, the transmission 39 has a configuration in which the first power transmission path PT1 and the second power transmission path PT2 are provided in parallel between the input shaft 22 and the output shaft 30, but a configuration in which one or more power transmission paths may be additionally provided in parallel in addition to these power transmission paths may be employed.

In the above embodiments, the mode switching clutch SOWC is provided as a power transmission mechanism in the first power transmission path PT1, but a one-way clutch that transmits power operating in one direction and intercepts power operating in the opposite direction may be provided instead of the mode switching clutch SOWC. In this case, since reverse travel using the first power transmission path PT1 is difficult, for example, a power transmission path for reverse travel may be provided in parallel with the first power transmission path PT1 and the second power transmission path PT2 for switching to reverse travel. Even when the one-way clutch which is provided instead of the mode switching clutch SOWC is out of order and the one-way clutch transmits power operating in two directions, it is possible to curb occurrence of a shock due to simultaneous transmission of power via the first power transmission path PT1 and the second power transmission path PT2 by performing the above-mentioned control.

In the above embodiments, the gear ratio EL in the first power transmission path PT1 is set to be lower than the lowest gear ratio γmax in the second power transmission path PT2, but the gear ratio EL in the first power transmission path PT1 may be set to be higher than the highest gear ratio γmin in the second power transmission path PT2. In this case, switching from the second power transmission path PT2 to the first power transmission path PT1 is defined as an upshift, and switching from the first power transmission path PT1 to the second power transmission path PT2 is defined as a downshift.

The above embodiments are merely exemplary and the present disclosure can be embodied in various forms in which the embodiments have been subjected to various modifications and improvements based on knowledge of those skilled in the art.

What is claimed is:

1. A control device for a vehicular transmission that is provided between an input shaft which is connected to a drive source in a power-transmittable manner and an output shaft which is connected to driving wheels in a power-transmittable manner and includes at least a first power transmission path and a second power transmission path which are provided in parallel, in which a first clutch and a power transmission mechanism are provided in the first power transmission path, a stepless gear shifting mechanism and a second clutch are provided in the second power transmission path, and the first clutch is disposed closer to the drive source than the power transmission mechanism,
wherein the power transmission mechanism includes a mode switching clutch or a one-way clutch that is able to switch to at least a one-way mode in which power operating in one direction is transmitted and power operating in the opposite direction is cut off, and
wherein switching to a travel mode in which power of the drive source is transmitted to the driving wheels via the first power transmission path is prohibited when a rotation speed difference between rotary members of the power transmission mechanism is equal to or less than a predetermined value during travel in a travel mode in which the power of the drive source is transmitted to the driving wheels via the second power transmission path.

2. The control device for a vehicular transmission according to claim 1, wherein the first clutch is disengaged when an amount of change of a rotation speed of the input shaft with the progress of switching is equal to or less than a predetermined value in a transition period of switching from the travel mode in which the power of the drive source is transmitted to the driving wheels via the first power transmission path to the travel mode in which the power of the drive source is transmitted to the driving wheels via the second power transmission path.

3. The control device for a vehicular transmission according to claim 1, wherein the first clutch is disengaged when deceleration of a vehicle in a transition period of switching from the travel mode in which the power of the drive source is transmitted to the driving wheels via the first power transmission path to the travel mode in which the power of the drive source is transmitted to the driving wheels via the second power transmission path is equal to or greater than a predetermined value.
